(19) United States
(12) Patent Application Publication
(10) Pub. No.: US 2023/0307699 A1
(43) Pub. Date: Sep. 28, 2023

(54) ALL SOLID STATE BATTERY AND METHOD FOR PRODUCING ALL SOLID STATE BATTERY

(71) Applicant: TOYOTA JIDOSHA KABUSHIKI KAISHA, Toyota-shi Aichi-ken (JP)

(72) Inventors: Ximeng LI, Susono-shi Shizuoka-ken (JP); Masumi Sato, Toyota-shi Aichi-ken (JP); Masashi Kodama, Hadano-shi Kanagawa-ken (JP); Keisuke Morita, Susono-shi Shizuoka-ken (JP)

(73) Assignee: TOYOTA JIDOSHA KABUSHIKI KAISHA, Toyota-shi Aichi-ken (JP)

(21) Appl. No.: 18/121,847

(22) Filed: Mar. 15, 2023

(30) Foreign Application Priority Data
Mar. 24, 2022 (JP) 2022-047810

(51) Int. Cl. H01M 10/0562; H01M 4/04; H01M 4/62; H01M 4/38

(52) U.S. Cl. CPC H01M 10/0562; H01M 4/0404; H01M 4/628; H01M 4/382; H01M 2004/027

(57) ABSTRACT

A main object of the present disclosure is to provide an all solid state battery in which occurrence of short circuit is inhibited. The present disclosure achieves the object by providing an all solid state battery comprising an anode including at least an anode current collector, a cathode, and a solid electrolyte layer arranged between the anode and the cathode; wherein a protective layer containing Mg is arranged between the anode current collector and the solid electrolyte layer; and the protective layer includes a mixture layer including a Mg-containing particle containing the Mg, and a solid electrolyte.

### CROSS-REFERENCE TO RELATED APPLICATIONS

This application is based upon and claims the benefit of priority of the prior Japanese Patent Application No. 2022-047810, filed on Mar. 24, 2022, the entire contents of which are incorporated herein by reference.

### TECHNICAL FIELD

The present disclosure relates to an all solid state battery and a method for producing the all solid state battery.

### BACKGROUND ART

An all solid state battery is a battery including a solid electrolyte layer between a cathode and an anode, and one of the effects thereof is that the simplification of a safety device may be more easily achieved compared to a liquid-based battery including a liquid electrolyte containing a flammable organic solvent.

For example, Patent Literature 1 discloses that an all solid state battery, which utilizes a deposition and dissolution reactions of a metal lithium as an anode reaction, includes a metal Mg layer formed on an anode current collector. Also, Patent Literature 2 discloses that an all solid state battery includes, between an anode layer and a solid electrolyte layer, a protective layer including a composite metal oxide represented by Li-M-O.

### CITATION LIST

### Patent Literatures

Patent Literature 1: Japanese Patent Application Laid-Open (JP-A) No. 2020-184513
Patent Literature 2: JP-A No. 2020-184407

### SUMMARY OF DISCLOSURE

### Technical Problem

From the viewpoint of improving performance of an all solid state battery, restraining the occurrence of short circuit (such as slight short circuit that degrades performance) is required. The present disclosure has been made in view of the above circumstances and a main object thereof is to provide an all solid state battery in which occurrence of short circuit is inhibited.

### Solution to Problem

In order to achieve the object, the present disclosure provides an all solid state battery comprising an anode including at least an anode current collector, a cathode, and a solid electrolyte layer arranged between the anode and the cathode; wherein a protective layer containing Mg is arranged between the anode current collector and the solid electrolyte layer; and the protective layer includes a mixture layer including a Mg-containing particle containing the Mg, and a solid electrolyte.

According to the present disclosure, a protective layer including a mixture layer containing a Mg-containing particle and a solid electrolyte is arranged between the anode current collector and the solid electrolyte layer, and thus the occurrence of short circuit may be inhibited in the all solid state battery.

In the disclosure, in the mixture layer, a proportion of the Mg-containing particle with respect to a total of the Mg-containing particle and the solid electrolyte may be 10 weight % or more and 90 weight % or less.

In the disclosure, each of the solid electrolyte included in the solid electrolyte layer and the solid electrolyte included in the mixture layer may be a sulfide solid electrolyte.

In the disclosure, the protective layer may include a Mg layer that is a metal thin film containing the Mg, in a position closer to the anode current collector side than the mixture layer.

In the disclosure, the anode may include an anode active material layer containing a deposited Li between the anode current collector and the solid electrolyte layer.

In the disclosure, the anode may not include an anode active material layer containing a deposited Li between the anode current collector and the solid electrolyte layer.

In the disclosure, a filling rate of the mixture layer may be 70% or more.

The present disclosure also provides a method for producing an all solid state battery including an anode including at least an anode current collector, a cathode, and a solid electrolyte layer arranged between the anode and the cathode; wherein a protective layer containing Mg is arranged between the anode current collector and the solid electrolyte layer; and the protective layer includes a mixture layer including a Mg-containing particle containing the Mg, and a sulfide glass; the method comprising: a particle layer forming step of forming a particle layer including the Mg-containing particle on the anode current collector; a precursor layer forming step of forming a precursor layer by impregnating the particle layer with a sulfide glass solution in which the sulfide glass is dissolved in a solvent; and a mixture layer forming step of obtaining the mixture layer by drying the precursor layer.

According to the present disclosure, a mixture layer is formed by impregnating the particle layer containing the Mg-containing particle, with a sulfide glass solution, and then drying thereof, and thus occurrence of short circuit may be inhibited, and an all solid state battery with cycle characteristics may be obtained.

In the disclosure, the sulfide glass may have a composition represented by Li₇₋ₐPS₆₋ₐXₐ, wherein X is at least one kind of Cl, Br, and I, and “a” is a number of 0 or more and 2 or less.

In the disclosure, a content of the sulfide glass in the sulfide glass solution may be 10 weight % or more and 30 weight % or less.

In the disclosure, the drying in the mixture layer forming step may be at a temperature of 60° C. or more and 80° C. or less.

### Effects of Disclosure

The present disclosure exhibits an effect of providing an all solid state battery in which occurrence of short circuit is inhibited.

### BRIEF DESCRIPTION OF DRAWINGS

FIG. 1 is a schematic cross-sectional view exemplifying the all solid state battery in the present disclosure.

FIG. 2 is a schematic cross-sectional view exemplifying the all solid state battery in the present disclosure.

FIG. 3 is a schematic cross-sectional view exemplifying the all solid state battery in the present disclosure.

FIG. 4 is a flow chart exemplifying the method for producing the all solid state battery in the present disclosure.

FIG. 5A is a schematic cross-sectional view exemplifying a part of the all solid state batteries produced in Examples.

FIG. 5B is a schematic cross-sectional view exemplifying a part of the all solid state batteries produced in Comparative Examples.

FIG. 6 is a chart showing the result of cycle tests in Example 4 and Comparative Examples 3 to 4.

### DESCRIPTION OF EMBODIMENTS

The all solid state battery and the method for producing the all solid state battery in the present disclosure will be hereinafter explained in details. In the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

A. All Solid State Battery

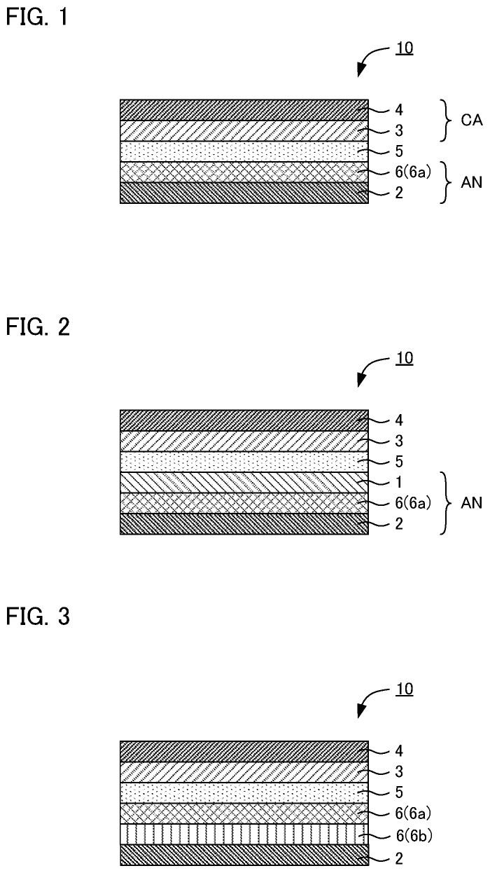

FIG. 1 is a schematic cross-sectional view exemplifying the all solid state battery in the present disclosure. All solid state battery 10 illustrated in FIG. 1 includes anode AN including anode current collector 2, cathode CA including cathode active material layer 3 and cathode current collector 4, and solid electrolyte layer 5 arranged between the anode AN and the cathode CA. Further, in FIG. 1, between the anode current collector 2 and the solid electrolyte layer 5, protective layer 6 containing Mg is arranged. The protective layer 6 includes a mixture layer 6a including a Mg-containing particle containing the Mg, and a solid electrolyte. Incidentally, as shown in FIG. 1, the protective layer 6 may be regarded as a constituent element of the anode AN.

For example, when the all solid state battery shown in FIG. 1 is charged, an anode active material layer containing a deposited Li will be formed between the anode current collector 2 and the solid electrolyte layer 5. In specific, as shown in FIG. 2, anode active material layer 1 containing a deposited Li will be formed between the anode current collector 2 and the solid electrolyte layer 5. In this manner, the all solid state battery in the present disclosure may be a battery utilizing deposition-dissolution reactions of a metal lithium. In FIG. 2, the anode active material layer 1 is formed between the mixture layer 6a and the solid electrolyte layer 5, but depending on the charge conditions and the charge state, there may be a case where the anode active material layer 1 is formed between the mixture layer 6a and the anode current collector 2. Also, there may be a case where the mixture layer 6a may include a void inside, and Li may be deposited in that void. Also, it is presumed that the Mg included in the protective layer 6 is alloyed with Li.

According to the present disclosure, a protective layer including a mixture layer containing a Mg-containing particle and a solid electrolyte is arranged between the anode current collector and the solid electrolyte layer, and thus the occurrence of short circuit may be inhibited in the all solid state battery.

As in Patent Literature 1, in an all solid state battery utilizing depositing and dissolving reactions of a metal lithium as a reaction of an anode, a technique of arranging a metal Mg layer on an anode current collector has been known. By arranging the metal Mg layer, charge and discharge efficiency of the all solid state battery can be improved. Meanwhile, when a current load is high, there is a risk that uneven deposition and dissolution of the metal lithium may occur, and as a result, there is a risk of short circuit occurrence. Also, when Li is deposited unevenly, there is a risk that the deposited Li layer (anode active material layer) may be peeled off. As a result, there is a risk that the battery resistance of the all solid state battery may increase, and there is a risk that the capacity durability may decrease.

In contrast, in the present disclosure, the protective layer is provided with a mixture layer including a Mg-containing particle and a sold electrolyte, and thus occurrence of short circuit is inhibited in the all solid state battery. This is presumably because the solid electrolyte included in the solid electrolyte layer contacts the solid electrolyte included in the mixture layer, and thus the power concentration is suppressed and a local deposition of Li is suppressed to inhibit the occurrence of short circuit. Also, it is considered that the deposited Li is alloyed with the Mg-containing particle, and that Li is dispersed in the alloy. Thereby, it is considered that the deposited Li layer and the mixture layer are adhered by an anchor effect, and the peel-off of the deposited Li layer is suppressed. Further, the peel-off of the deposited Li layer is suppressed, and thus re-dissolution of the deposited Li layer easily occurs during discharge, and the increase in battery resistance can be suppressed. In this manner, the protective layer includes the mixture layer provided with the Mg-containing particle and the solid electrolyte, and thus the input and output characteristics of Li in the interface of the solid electrolyte layer in the anode layer side improves, and the occurrence of short circuit is inhibited in the all solid state battery.

1. Protective Layer

The protective layer in the present disclosure is a layer arranged between the anode current collector and solid electrolyte layer, and contains Mg. The protective layer includes at least a mixture layer including a Mg-containing particle containing the Mg, and a solid electrolyte.

(1) Mixture Layer

The mixture layer includes a Mg-containing particle containing the Mg, and a solid electrolyte. In the mixture layer, the Mg-containing particle and the solid electrolyte are mixed.

(i) Mg-Containing Particle

The Mg-containing particle contains Mg. The Mg-containing particle may be a particle of a simple substance of Mg (Mg particle), and may be a particle containing Mg and an element other than Mg. Examples of the element other than Mg may include Li and a metal (including half metal) other than Li. Also, an additional example of the element other than Mg may be non-metal such as O.

On the Mg-containing particle, the core of metal Li tends to be stably formed, and thus more stable precipitation of Li is possible when the Mg-containing particle is used. Also, Mg has wide composition region to form a single phase with Li, and thus more efficient dissolution and deposition of Li is possible.

The Mg-containing particle may be an alloy particle (Mg alloy particle) containing Mg and a metal other than Mg. In some embodiments, the Mg alloy particle is an alloy containing Mg as a main component. Examples of a metal M other than Mg in the Mg alloy particle may include Li, Au, Al and Ni. The Mg alloy particle may contain just one kind of the metal M, and may contain two kinds or more of the metal M. Also, the Mg-containing particle may or may not contain Li. In the former case, the alloy particle may include an alloy of β single phase of Li and Mg.

The Mg-containing particle may be an oxide particle (Mg oxide particle) containing Mg and O. Examples of the Mg oxide particle may include an oxide of a simple substance of Mg, and a composite metal oxide represented by Mg-M′-O, provided that M′ is at least one of Li, Au, Al and Ni. In some embodiments, the Mg oxide particle contains at least Li as M′. M′ may or may not contain a metal other than Li. In the former case, M′ may be one kind of metal other than Li, and may be two or more kinds. Meanwhile, the Mg-containing particle may not contain O.

The Mg-containing particle may be a primary particle, and may be a secondary particle which is aggregation of the primary particles. In some embodiments, the average particle size (D₅₀) of the Mg-containing particle is small. When the average particle size is small, the dispersibility of the Mg-containing particle in the mixture layer improves, and reaction point with Li increases; thus, it is more effective to inhibit short circuit. The average particle size (D₅₀) of the Mg-containing particle is, for example, 500 nm or more, and may be 800 nm or more. Meanwhile, the average particle size (D₅₀) of the Mg-containing particle is, for example, 20 μm or less, may be 10 μm or less, and may be 5 μm or less. Incidentally, as the average particle size, a value calculated from a laser diffraction particle distribution meter, or a value measured based on an image analysis using an electron microscope such as SEM.

Also, the average particle size (D₅₀) of the Mg-containing particle may be the same as the average particle size (D₅₀) of the later described solid electrolyte, and may be larger or smaller than thereof. Here, when X designates the average particle size of the Mg-containing particle, and Y designates the average particle size of the solid electrolyte, the average particle size (D₅₀) of the Mg-containing particle and the average particle size (D₅₀) of the solid electrolyte being the same means that the difference between the two (absolute value of X−Y) is 5 μm or less. The average particle size (D₅₀) of the Mg-containing particle is larger than the average particle size (D₅₀) of the solid electrolyte means that X−Y is larger than 5 μm. In this case, X/Y is, for example, 1.2 or more, may be 2 or more, and may be 5 or more. Meanwhile, X/Y is, for example, 100 or less and may be 50 or less. The average particle size (D₅₀) of the Mg-containing particle is smaller than the average particle size (D₅₀) of the solid electrolyte means that Y−X is larger than 5 μm. In this case, Y/X is, for example, 1.2 or more, may be 2 or more, and may be 5 or more. Meanwhile, Y/X is, for example, 100 or less and may be 50 or less.

The proportion of the Mg-containing particle in the mixture layer is, for example, 10 weight % or more, and may be 30 weight % or more. Meanwhile, the proportion of the Mg-containing particle is, for example, 90 weight % or less, and may be 70 weight % or less.

(ii) Solid Electrolyte

The mixture layer contains a solid electrolyte. Examples of the solid electrolyte may include an inorganic solid electrolyte such as a sulfide solid electrolyte, an oxide solid electrolyte, a nitride solid electrolyte, a halide solid electrolyte, and a complex hydride. In some embodiments, the solid electrolyte is a sulfide solid electrolyte. The sulfide solid electrolyte usually contains sulfur (S) as a main component of the anion element. The sulfide solid electrolyte usually contains sulfur (S) as a main component of the anion element. The oxide solid electrolyte, the nitride solid electrolyte, and the halide solid electrolyte usually contains, as a main component of the anion, oxygen (O), nitrogen (N), and halogen (X) respectively.

In some embodiments, the sulfide solid electrolyte contains, for example, a Li element, an X element (X is at least one kind of P, As, Sb, Si, Ge, Sn, B, Al, Ga, and In), and a S element. Also, the sulfide solid electrolyte may further contain at least one of an O element and a halogen element. In some embodiments, the sulfide solid electrolyte contains a S element as a main component of the anion element.

The sulfide solid electrolyte may be, a glass-based sulfide solid electrolyte (sulfide glass), may be a glass ceramic-based sulfide solid electrolyte, and may be a crystal-based sulfide solid electrolyte. The sulfide glass is amorphous. In some embodiments, the sulfide glass has a glass transfer temperature (Tg). Also, when the sulfide solid electrolyte includes a crystal phase, examples of the crystal phase may include a Thio-LISICON type crystal phase, a LGPS type crystal phase, and an argyrodite type crystal phase.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n is a positive number; Z is any one of Ge, Zn, and Ga), Li₂S—GeS₂, Li₂S—SiS₂—Li₃PO₄, and Li₂S—SiS₂—LiₓMO_{y} (provided that x and y is a positive number; M is any one of P, Si, Ge, B, Al, Ga, and In).

There are no particular limitations on the composition of the sulfide solid electrolyte, and examples thereof may include xLi₂S·(100-x)P₂S₅(70≤x≤80), and yLiI·zLiBr·(100-y-z) (xLi₂S·(1-x) P₂S₅) (0.7≤x≤0.8, 0≤y≤30, 0≤z≤30).

The sulfide solid electrolyte may have a composition represented by a general formula: Li₄₋ₓGe₁₋ₓPₓS₄ (0<x<1). In the general formula, at least a part of Ge may be substituted with at least one of Sb, Si, Sn, B, Al, Ga, In, Ti, Zr, V and Nb. In the general formula, at least a part of P may be substituted with at least one of Sb, Si, Sn, B, Al, Ga, In, Ti, Zr, V and Nb. In the general formula, a part of Li may be substituted with at least one of Na, K, Mg, Ca, and Zn. In the general formula, a part of S may be substituted with a halogen (at least one of F, Cl, Br, and I).

The sulfide glass may have a composition represented by, for example, Li₇₋ₐPS₆₋ₐXₐ, wherein X is at least one kind of Cl, Br, and I, and “a” is a number of 0 or more and 2 or less. The “a” may be 0 and may be larger than 0. In the latter case, the “a” may be 0.1 or more, may be 0.5 or more, and may be 1 or more. Also, the “a” may be 1.8 or less, and may be 1.5 or less.

The solid electrolyte may be in a glass shape, and may include a crystal phase. The shape of the solid electrolyte is usually a granular shape. The average particle size (D₅₀) of the solid electrolyte is, for example, 0.01 μm or more. Meanwhile, the average particle size (D₅₀) of the solid electrolyte is, for example, 10 μm or less, and may be 5 μm or less. Ion conductivity of the solid electrolyte at 25° C. is, for example, 1*10⁻⁴ S/cm or more, and may be 1*10⁻³ S/cm or more.

The proportion of the solid electrolyte in the mixture layer is, for example, 10 weight % or more, and may be 30 weight % or more. Meanwhile, the proportion of the solid electrolyte in the mixture layer is, for example, 90 weight % or less, and may be 70 weight % or less. Also, in the mixture layer, the proportion of the Mg-containing particle with respect to the total of the Mg-containing particle and the solid electrolyte is, for example, 10 weight % or more, and may be 30 weight % or more. Meanwhile, the proportion of the Mg-containing particle is, for example, 90 weight % or less, and may be 70 weight % or less.

(iii) Mixture Layer

In some embodiments, the filling rate of the mixture layer is not particularly limited, but may be high. The reason therefor is that, when the filling rate of the mixture layer is high, the cycle characteristics of the all solid state battery will be well. The filling rate of the mixture layer is, for example, 70% or more, may be 80% or more, may be 90% or more, may be 95% or more, and may be 98% or more. Also, the filling rate of the mixture layer may be 100%. Incidentally, the filling rate of the mixture layer can be calculated from the following method. That is, when a total of volumes obtained by dividing weight of each materials (such as Mg-containing particle and solid electrolyte) included in the mixture layer by true density of each materials is regarded as “volume of mixture layer calculated from true density”, and a volume calculated from the actual size of the mixture layer is regarded as “actual volume of mixture layer”, the filling rate (%) can be obtained from the following equation:

Filling rate (%)=“Volume of mixture layer calculated from true density”/“Actual volume of mixture layer”*100.

The mixture layer may contain a binder as required. Thereby, occurrence of a crack of the mixture layer itself can be inhibited. Examples of the binder may include a fluorine-based binder and a rubber-based binder. Examples of the fluorine-based binder may include polyvinylidene fluoride (PVDF) and polytetra fluoroethylene (PTFE). Also, examples of the rubber-based binder may include butadiene rubber (BR), acrylate butadiene rubber (ABR), and styrene butadiene rubber (SBR). The thickness of the mixture layer is, for example, 0.1 μm or more and 1000 μm or less.

The protective layer in the present disclosure may include just one layer of the mixture layer, and may include two layers or more thereof. Also, examples of the method for forming the mixture layer may include a method of pasting a slurry containing at least the Mg-containing particle and the solid electrolyte, on a substrate. Also, there is a method wherein a particle layer containing a Mg-containing particle is formed, and then the particle layer is impregnated with an electrolyte solution in which a solid electrolyte is dissolved in a solvent, and then the product is dried.

(2) Mg Layer

As shown in FIG. 3, protective layer 6 may include Mg layer 6b containing the Mg but not containing a solid electrolyte, in a position closer to the anode current collector 2 side than the mixture layer 6a side. By arranging the Mg layer between the anode current collector and the mixture layer, dispersion of Li can be further promoted. Also, since the solid electrolyte included in the mixture layer does not directly contact the anode current collector, the deposition origin of Li can be just on Mg. Thereby, Li can be further uniformly deposited.

The Mg layer is a layer of which proportion of Mg is the most among all the constituents therein. The proportion of Mg in the Mg layer is, for example, 50 mol % or more, may be 70 mol % or more, may be 90 mol % or more, and may be 100 mol %. Examples of the Mg layer may include a metal thin film (such as a vapor deposition film) containing Mg, and a layer including the Mg-containing particle. In some embodiments, the metal thin film containing Mg mainly composed of Mg. Also, the contents of the Mg-containing particle are as described above. The Mg layer may be a layer containing just the Mg-containing particle.

The thickness of the Mg layer is, for example, 10 nm or more and 10 μm or less. Above all, when the Mg layer is the metal thin film containing Mg, the thickness is 5000 nm or less, may be 3000 nm or less, may be 1000 nm or less, and may be 700 nm or less. Meanwhile, the thickness of the Mg layer may be 50 nm or more, and may be 100 nm or more.

The protective layer in the present disclosure may include just one layer of the Mg layer, and may include two layers or more thereof. Meanwhile, the protective layer in the present disclosure may not include the Mg layer. Examples of the method for forming the Mg layer may include a method of forming a film on the anode current collector by a PVD method such as a vapor deposition method and a spattering method or by a plating method such as an electrolyte plating method and a non-electrolyte plating method; and a method of pressing the Mg-containing particle.

Also, as shown in FIG. 3, the Mg layer 6b and the mixture layer 6a may directly contact each other. Similarly, the mixture layer 6a and the solid electrolyte layer 5 may directly contact each other. Similarly, the Mg layer 6b and the anode current collector 2 may directly contact each other. Also, as shown in FIG. 1, the mixture layer 6a and the anode current collector 2 may directly contact each other.

2. Anode

The anode in the present disclosure includes at least an anode current collector. As shown in FIG. 1, anode AN may not include an anode active material layer containing deposited Li between the anode current collector 2 and the solid electrolyte layer 5. Also, as shown in FIG. 2, the anode AN may include anode active material layer 1 containing deposited Li between the anode current collector 2 and the solid electrolyte layer 5.

In some embodiments, when the anode includes an anode active material layer, the anode active material layer contains at least one of a simple substance of Li and a Li alloy as an anode active material. Incidentally, in the present disclosure, a simple substance of Li and a Li alloy may be referred to as a Li-based active material in general. When the anode active material layer contains the Li-based active material, the Mg-containing particle in the protective layer may or may not contain Li.

For example, in an all solid state battery produced by using a Li foil or a Li alloy foil as the anode active material, and using a Mg particle as the Mg-containing particle, the Mg particle is presumed to be alloyed with Li at the time of initial discharge. Meanwhile, in an all solid state battery produced by not arranging an anode active material layer, but using a Mg particle as the Mg-containing particle, and using a cathode active material containing Li, the Mg particle is presumed to be alloyed with Li at the time of initial charge.

The anode active material layer may contain just one of a simple substance of Li and a Li alloy as the Li-based active material, and may contain the both of a simple substance of Li and a Li alloy.

In some embodiments, the Li alloy is an alloy containing a Li element as a main component. Examples of the Li alloy may include Li—Au, Li—Mg, Li—Sn, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. The Li alloy may be just one kind, and may be two kinds or more.

Examples of the shape of the Li-based active material may include a foil shape and a granular shape. Also, the Li-based active material may be a deposited metal lithium.

The thickness of the anode active material layer is not particularly limited; for example, it is 1 nm or more and 1000 μm or less, and may be 1 nm or more and 500 μm or less.

Examples of the material for the anode current collector may include SUS, Cu, Ni, In, Al and C. Examples of the shape of the anode current collector may include a foil shape, a mesh shape, and a porous shape. Also, the surface of the anode current collector may or may not be subjected to a roughening treatment. Smooth surface of the anode current collector is desirable from the viewpoint of wettability. Also, rough surface of the anode current collector is desirable from the viewpoint that the contact area of the anode current collector increases. When the contact area increases, the interface bonding will be stronger, and peel-off of materials may be further inhibited. The surface roughness (Ra) of the anode current collector is, for example, 0.1 μm or more, may be 0.3 μm or more, and may be 0.5 μm or more. Meanwhile, the surface roughness (Ra) of the anode current collector is, for example, 5 μm or less and may be 3 μm or less. The surface roughness (Ra) can be obtained by a method according to JIS B0601.

4. Cathode

In some embodiments, the cathode in the present disclosure includes a cathode active material layer and a cathode current collector. The cathode active material layer in the present disclosure is a layer containing at least a cathode active material. Also, the cathode active material layer may contain at least one of a solid electrolyte, a conductive material, and a binder, as required.

The cathode active material is not particularly limited if it is an active material having higher reaction potential than that of the anode active material, and cathode active materials that can be used in an all solid state battery may be used. The cathode active material may or may not contain a lithium element.

Examples of the cathode active material including a lithium element may include a lithium oxide. Examples of the lithium oxide may include a rock salt bed type active material such as LiCoO₂, LiMnO₂, LiNiO₂, LiVO₂, and LiNi_{1/3}Co_{1/3}Mn_{1/3}O₂; a spinel type active material such as Li₄Ti₅O₁₂, LiMn₂O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄; and an olivine type active material such as LiFePO₄, LiMnPO₄, LiNiPO₄, and LiCoPO₄. Also, additional examples of the cathode active material including a lithium element may include LiCoN, Li₂SiO₃, Li₄SiO₄, a lithium sulfide (Li₂S), and a lithium polysulfide (Li₂Sₓ, 2≤x≤8).

Meanwhile, examples of the cathode active material not including a lithium element may include a transition metal oxide such as V₂O₅ and MoO₃; a S-based active material such as S and TiS₂; a Si-based active material such as Si and SiO; and a lithium storing intermetallic compound such as Mg₂Sn, Mg₂Ge, Mg₂Sb and Cu₃Sb.

Also, a coating layer containing an ion conductive oxide may be formed on the surface of the cathode active material. The coating layer prevents the reaction of the cathode active material and the solid electrolyte. Examples of the ion conductive oxide may include LiNbO₃, Li₄Ti₅O₁₂, and Li₃PO₄.

The proportion of the cathode active material in the cathode active material layer is, for example, 20 weight % or more, may be 30 weight % or more and may be 40 weight % or more. Meanwhile, the proportion of the cathode active material in the cathode active material layer is, for example, 80 weight % or less, may be 70 weight % or less and may be 60 weight % or less.

Examples of the conductive material may include a carbon material. Specific examples of the carbon material may include acetylene black, Ketjen black, VGCF and graphite. The solid electrolyte and the binder are in the same contents as those described in “1. Protective layer”. Also, the thickness of the cathode active material layer is, for example, 0.1 μm or more and 1000 μm or less.

The cathode current collector is, for example, arranged in the opposite side to the solid electrolyte layer on the basis of the cathode active material layer. Examples of the material for the cathode current collector may include Al, Ni and C. Examples of the shape of the cathode current collector may include a foil shape, a mesh shape, and a porous shape.

5. Solid Electrolyte Layer

The solid electrolyte layer in the present disclosure is a layer containing at least a solid electrolyte. Also, the solid electrolyte layer may contain a binder as required. The solid electrolyte and the binder are in the same contents as those described in “1. Protective layer”.

In some embodiments, the solid electrolyte included in the solid electrolyte layer and the solid electrolyte included in the mixture layer are a same kind of solid electrolyte. The reason therefor is to improve the adherence of the solid electrolyte layer and the mixture layer. In some embodiments, when the solid electrolyte included in the solid electrolyte layer is a sulfide solid electrolyte, the solid electrolyte included in the mixture layer is also the sulfide solid electrolyte. The same applies when other inorganic solid electrolytes such as an oxide solid electrolyte, and a nitride solid electrolyte are used instead of the sulfide solid electrolyte. Also, the thickness of the solid electrolyte layer is, for example, 0.1 μm or more and 1000 μm or less.

6. All Solid State Battery

The all solid state battery in the present disclosure may further include a restraining jig that applies a restraining pressure along with the thickness direction of the cathode, the solid electrolyte layer and the anode. As the restraining jig, known jigs may be used. The restraining pressure is, for example, 0.1 MPa or more and may be 1 MPa or more. Meanwhile, the restraining pressure is, for example, 50 MPa or less, may be 20 MPa or less, may be 15 MPa or less, and may be 10 MPa or less.

The kind of the all solid state battery in the present disclosure is not particularly limited, but is typically a lithium ion secondary battery. The all solid state battery in the present disclosure may be a single battery and may be a layered battery. The layered battery may be a monopolar layered battery (layered battery connected in parallel), and may be a bipolar layered battery (layered battery connected in series). Examples of the shape of the battery may include a coin shape, a laminate shape, a cylindrical shape and a square shape.

Examples of the applications of the all solid state battery in the present disclosure may include a power source for vehicles such as hybrid electric vehicles (HEV), plug-in hybrid electric vehicles (PHEV), battery electric vehicles (BEV), gasoline-fueled automobiles and diesel powered automobiles. Also, the all solid state battery in the present disclosure may be used as a power source for moving bodies other than vehicles (such as rail road transportation, vessel and airplane), and may be used as a power source for electronic products such as information processing equipment.

B. Method for Producing all Solid State Battery

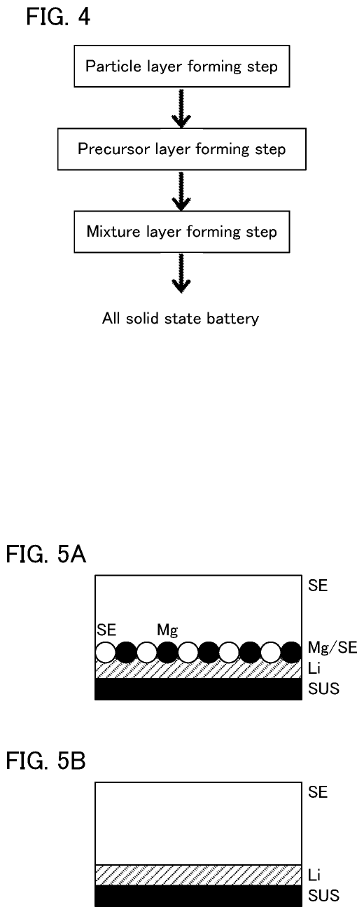

FIG. 4 is a flow chart exemplifying the method for producing the all solid state battery in the present disclosure. In the production method shown in FIG. 4, first, a particle layer including a Mg-containing particle is formed on an anode current collector (particle layer forming step). Next, the particle layer is impregnated with a sulfide glass solution in which a sulfide glass is dissolved in a solvent, and a precursor layer is formed (precursor layer forming step). Next, the precursor layer is dried to obtain a mixture layer (mixture layer forming step).

According to the present disclosure, a mixture layer if formed by impregnating the particle layer containing the Mg-containing particle, with a sulfide glass solution, and then drying thereof, and thus occurrence of short circuit may be inhibited, and an all solid state battery with cycle characteristics may be obtained. In specific, the mixture layer contains the Mg-containing particle and the sulfide glass, and thus the all solid state battery in which occurrence of short circuit is inhibited, may be obtained. Also, by impregnating the particle layer with the sulfide glass solution, the precursor layer is formed. On this occasion, the sulfide glass solution goes into voids inside the particle layer (such as voids among Mg-containing particles), and thus, through drying the product thereafter, the mixture layer with high filling rate may be obtained. As a result, an all solid state battery with cycle characteristics may be obtained. Also, when the protective layer (Mg layer) is formed by a so-called vapor deposition method, although the filling rate of the protective layer may be high, it will be difficult to form the protective layer when the battery size is increased (when scaling up). Also, by the vapor deposition method, usually, it is difficult to form a mixture layer containing the Mg-containing particle and the sulfide glass.

1. Particle Layer Forming Step

The particle layer forming step is a step of forming a particle layer including a Mg-containing particle on an anode current collector. The Mg-containing particle and the anode current collector are in the same contents as those described in “A. All solid state batter”.

In the particle layer forming step, for example, the particle layer is formed by pasting and drying slurry formed by dispersing the Mg-containing particle in a solvent (dispersion medium). Examples of the solvent (dispersion medium) may include an organic solvent such as mesitylene. Also, a binder may be added to the slurry. The binder is in the same contents as those described in “A. All solid state battery”.

The slurry may be directly pasted on the anode current collector. Meanwhile, the slurry may be pasted on the above described Mg layer formed on the anode current collector. Examples of the method for pasting the slurry may include a doctor blade method.

2. Precursor Layer Forming Step

The precursor layer forming step is a step of forming a precursor layer of the mixture layer by impregnating the particle layer with a sulfide glass solution in which a sulfide glass is dissolved in a solvent.

The sulfide glass (glass-based sulfide solid electrolyte) is in the same contents as those described in “A. All solid state battery”. In some embodiments, the sulfide glass has a composition represented by Li₇₋ₐPS₆₋ₐXₐ, wherein X is at least one kind of Cl, Br, and I, and “a” is a number of 0 or more and 2 or less.

The sulfide glass may be obtained by, for example, amorphizing a raw material composition. Examples of the raw material composition may include a mixture of a lithium halide, Li₂S and P₂S₅. Examples of treatments of amorphizing may include mechanical milling.

The sulfide glass solution may be obtained by mixing the sulfide glass with a solvent. Examples of the solvent may include an alcohol-based solvent with 1 or more and 10 or less carbon atoms. In some embodiments, the alcohol-based solvent is ethanol in particular. In the sulfide glass solution, the sulfide glass may be completely dissolved in the solvent, and may be partially dissolved (the sulfide glass solution may contain a sulfide glass not dissolved).

The content of the sulfide glass in the sulfide glass solution is, for example, 10 weight % or more, and may be 15 weight % or more. Meanwhile, the content of the sulfide glass is, for example, 30 weight % or less, may be 25 weight % or less, and may be 20 weight % or less. When the content is too much, it is difficult to impregnate the particle layer with the sulfide glass well. Meanwhile, when the content is too little, there is a risk that the later described drying time may be long.

The method for impregnating the particle layer with the sulfide glass is not particularly limited, as long as the method allows the particle layer to contact the sulfide glass solution. Examples of the method for impregnating may include a method of dropping the sulfide glass solution to the particle layer.

3. Mixture Layer Forming Step

The mixture layer forming step is a step of obtaining a mixture layer by drying the precursor layer. The mixture layer is in the same contents as those described in “A. All solid state battery”. In the mixture layer forming step, the solvent included in the sulfide glass solution is volatilized.

Drying may be natural drying, and may be heating drying. In the latter case, the drying temperature is not limited if the temperature allows the liquid-based component to be volatilized, and for example, it is 60° C. or more and 80° C. or less. With such a temperature, the liquid-based component may be gently volatilized, and occurrence of voids in the mixture layer can be inhibited. As a result, the filling rate of the mixture layer may be further increased.

The drying time is not particularly limited, and for example, it is 5 minutes or more and 1 hour or less. Also, the drying atmosphere may be an air pressure atmosphere, and may be a reduced pressure atmosphere. Examples of the reduced pressure atmosphere may include a vacuum atmosphere.

Also, the mixture layer forming step may include one step of the drying treatment, and may include two steps of the drying treatment. In the latter case, in some embodiments, temperature T1 in the drying treatment in the first step is the above described drying temperature, and temperature T2 in the drying treatment in the second step is higher than T1. T2−T1 is, for example, 50° C. or more. When the mixture layer forming step includes two steps of the drying treatment, the liquid-based component is more certainly volatilized while inhibiting the occurrence of voids in the mixture layer.

4. Other Steps

The method for producing the all solid state battery in the present disclosure may produce an anode including at least an anode current collector and a protective layer, by the above described steps. Also, usually, the method for producing the all solid state battery includes steps such as a solid electrolyte layer forming step, a cathode active material layer forming step, and a current collector arranging step. Examples of these steps may include general methods in the production of an all solid state battery. Also, by pre-charging the produced all solid state battery, a step of forming the above described Li layer (anode active material layer) may be included. The solid electrolyte layer, the cathode active material layer, the anode active material layer, and current collectors are in the same contents as those described in “A. All solid state battery”.

5. All Solid State Battery

The all solid state battery produced by the above described steps is in the same contents as those described in “A. All solid state battery”.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Protective Layer>

A binder solution (styrene butadiene solution) and a solvent (mesitylene and dibutylether) were projected into a container made of PP (polypropylene), and mixed for 3 minutes by a shaker. After that, a Mg particle (average particle size D₅₀=800 nm), and a solid electrolyte particle (sulfide solid electrolyte, 10LiI-15LiBr-75Li₃PS₄, average particle size D₅₀=800 nm) were weighed so as to be the Mg particle: the solid electrolyte particle=10:90 in the weight ratio, and projected into the container made of PP. The mixture was treated for 3 minutes by the shaker, treated for 30 seconds by an ultrasonic dispersion device, and the treatments were repeated twice to produce slurry. Successively, the slurry was pasted on a substrate (Al foil) using an applicator with 25 μm pasting gap and dried naturally. After confirming that the surface was dried visually, the product was dried for 30 minutes on a hot plate at 100° C. Thereby, a transfer member with a protective layer (mixture layer) formed on the substrate was produced.

<Production of all Solid State Battery>

An all solid state battery of a powder pressure type pressed cell (φ11.28 mm) was produced. In specific, 101.7 mg of a sulfide solid electrolyte (10LiI-15LiBr-75Li₃PS₄, average particle size D₅₀=0.5 μm) was put in a cylinder, pressed for 1 minute at the pressure of 588 MPa, and thereby a solid electrolyte layer was obtained. Next, the transfer member was layered so as to contact the solid electrolyte layer and the protective layer, and the product was pressed at 98 MPa, and then the Al foil was peeled off. Thereby, a layered body including the solid electrolyte layer and the protective layer was obtained. A SUS foil (φ11.28 mm) was arranged on the protective layer of the obtained layered body, and pressed at 98 MPa for 1 minute. Next, a Li metal foil (φ11.28 mm) was arranged on the surface of the solid electrolyte layer opposite to the protective layer side, and pressed at 98 MPa for 1 minute to obtain an electrode body. This electrode body was restrained by a torque of 2 N·m using three bolts. Thereby, an all solid state battery was obtained. Incidentally, if the all solid state battery obtained in Example 1 is charged, as shown in FIG. 5A, it is presumed that a Li layer will be deposited between the protective layer (Mg/SE) and the anode current collector (SUS). Also, there is a possibility that the Mg-containing particle may be alloyed with Li, and there is a possibility that Li is deposited in voids of the protective layer.

### Example 2 and Example 3

An all solid state battery was respectively obtained in the same manner as in Example 1 except that the weight ratio of the solid electrolyte and the Mg particle in the protective layer was changed to the values in Table 1. Incidentally, in Table 1, the solid electrolyte is described as “SE”.

### Comparative Example 1

An all solid state battery was obtained in the same manner as in Example 1 except that the protective layer was not arranged. Incidentally, if the all solid state battery obtained in Comparative Example 1 is charged, as shown in FIG. 5B, it is presumed that the Li layer will be deposited between the solid electrolyte layer (SE) and the anode current collector (SUS).

### Comparative Example 2

An all solid state battery was obtained in the same manner as in Example 1 except that the solid electrolyte was not used in the protective layer.

[Evaluation]

<Linear Sweep Voltammetry (LSV) Measurement>

The all solid state batteries obtained in Examples 1 to 3 and Comparative Examples 1 to 2 were placed still in a thermostatic tank at 25° C. for 1 hour. After that, the LSV measurement was conducted by sweeping at the speed of 0.1 mV/s from OCV potential until 1 V. The current value at the time the current behavior leaped was regarded as the short circuit limitation current. The results are shown in Table 1.

TABLE 1

| | | | Short |
|---|---|---|---|
| | | | circuit |
| | | | limitation |
| | Protective | Mg:SE | current |
| | layer | [wt] | [mA] |
| Example 1 | Mg + SE | 10:90 | 12 |
| Example 2 | Mg + SE | 50:50 | 12 |
| Example 3 | Mg + SE | 90:10 | 12 |
| Comp. Ex. 1 | — | — | 6 |
| Comp. Ex. 2 | Mg | 100:0 | 6 |

As shown in Table 1, it was confirmed that Examples 1 to 3 had higher value of the short circuit limitation current than that of Comparative Examples 1 to 2, and the occurrence of short circuit was inhibited. In this manner, it was confirmed that occurrence of short circuit was inhibited in the all solid state battery when the protective layer including the mixture layer containing the Mg-containing particle and the solid electrolyte, was arranged between the anode current collector and the solid electrolyte layer.

### Example 4

<Production of Mixture Layer>

A sulfide glass (Li₆PS₅Cl₁) was synthesized by a mechanical ball milling method. The synthesized sulfide glass was weighed to be 100 mg, and projected into a glass bottle. In the glass bottle, ethanol was dropped so that the solid content became 10 wt %, and then agitated for 3 minutes. Thereby, a yellow transparent sulfide glass solution was obtained.

A SBR (styrene butadiene rubber) binder was dissolved in mesitylene to prepare a SBR solution of 10 wt %. Mg particles (D₅₀=0.8 μm) was weighed to be 400 mg, and to the Mg particles, 22 mg of the SBR solution was added. Next, 1200 mg of mesitylene was added, agitated and dispersed, and thereby slurry was obtained. The obtained slurry was pasted on an anode current collector (SUS foil) with a blade made of SUS with 25 μm gap. Then, the product was dried at 50° C. for 5 minutes, and then dried at 120° C. for 1 hour. Thereby, a particle layer having a thickness of 5 μm was obtained on the anode current collector.

Next, a sulfide glass solution was dropped on the particle layer, and pasted with a blade made of SUS with 100 μm gap. Thereby, a precursor layer formed by impregnating the particle layer with the sulfide glass solution was obtained. The obtained precursor layer was dried in a globe box at 60° C. for 5 minutes, and then dried in a vacuum (0.01 atm) at 120° C. for 10 minutes. Thereby, a mixture layer including the Mg particle and the sulfide glass was formed on the anode current collector.

A NCA-based cathode active material, a sulfide glass solid electrolyte (Li₆PS₅Cl₁), and a conductive material (VGCF-H; Showa Denko K.K.) were weighed so as to be 78:19:3 in the volume ratio and 2 g, then mixed. To the obtained mixture, 1200 mg of butyl butyrate and 20 mg of a PVDF binder were added, and crushed by an ultrasonic homogenizer. Thereby, a cathode slurry was prepared. The prepared cathode slurry was pasted on an Al foil by a blade made of SUS with 300 μm gap, then dried at 100° C. for 1 hour. Thereby, a cathode film was obtained.

A sulfide glass (li₆PS₅Cl₁) was weighed to be 100 mg, projected into a cylindrical cylinder with Φ11.28, and pressure molded at 1 ton. Thereby, an electrolyte pellet was produced. The cathode film was arranged on one surface of the pellet, and the mixture layer was arranged on the surface of the pellet opposite to the cathode film, and pressed at 6 tons. The obtained layered body was restrained at the restraining pressure of 1 MPa. Thereby, an all solid state battery was produced.

### Comparative Example 3

An all solid state battery was produced in the same manner as in Example 4 except that the particle layer was used instead of the mixture layer.

### Comparative Example 4

By a vapor deposition method, a Mg vapor deposition film (film thickness: 1000 nm) was formed on an anode current collector (SUS foil). An all solid state battery was produced in the same manner as in Example 4 except that the Mg vapor deposition film was used instead of the mixture layer.

[Evaluation]

<Measurement of Filling Rate>

The mixture layer obtained in Example 4, the particle layer obtained in Comparative Example 3, and the Mg vapor deposition film obtained in Comparative Example 4 were respectively weighed, and projected into the cylindrical cylinder with Φ11.28, and restrained at 3 MPa. The thickness at that time was measured by a film thickness meter. The filling rate was calculated from the thickness measured and the weight weighed. The results are shown in Table 2.

<Cycle Test>

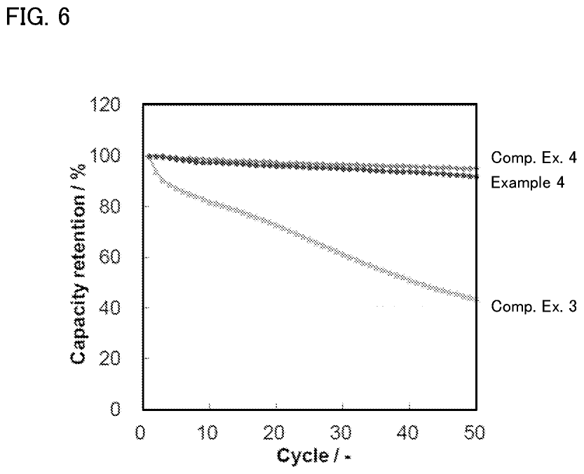

The charge and discharge were performed in the following conditions to obtain capacity durability. The results are shown in FIG. 6.
Temperature: 60° C.
Voltage range: 3.56 V to 4.14 V
Current density: 1.5 mA/cm²
Numbers of cycles: 50

TABLE 2

| | Mg weight | Filling rate |
|---|---|---|
| | (mg/cm²) | (%) |
| Example 4 | 0.7 | 98.9 |
| (Mixture layer | | |
| (Pasting + Impregnating)) | | |
| Comparative Example 3 | 0.7 | 67.8 |
| (Particle layer (Pasting)) | | |
| Comparative Example 4 | 0.9 | 99.7 |
| (Mg vapor deposition film) | | |

As shown in Table 2, the filling rate of the mixture layer in Example 4 was equally high as that of the Mg vapor deposition film in Comparative Example 4, and it was confirmed that extremely dense mixture layer was obtained. Further, the filling rate of the mixture layer in Example 4 was remarkably larger than that of the particle layer in Comparative Example 3. Also, as shown in FIG. 6, in Comparative Example 3, although the capacity decreased from the second cycle, in Comparative Example 4 and Example 4, the capacity durability was well even after 50 cycles. This is presumably because the contact of Mg and the solid electrolyte layer was well since the filling rates of the Mg vapor deposition film and the mixture layer were high in Comparative Example 4 and Example 4, and thus blocking of ion conducting path due to stress change along with Li dissolution and deposition was inhibited. As a result, in Comparative Example 4 and Example 4, it is considered that the deposited Li was not isolated and charge and discharge were conducted well. Also, when a vapor deposition method is used as in Comparative Example 4, it is difficult to form a protective layer when the battery size is increased (when scaling up). In contrast, when a pasting method as in Example 4 is used, there is an effect that formation of the protective layer is easy even when the battery size is increased. Also, it is presumed that the Mg itself included in the Mg vapor deposition film would expand and contract due to intercalation and desorption of Li, and thus there is a possibility that a crack may occur in the Mg vapor deposition film when the number of charge and discharge cycles is further increased. On the other hand, in the mixture layer in Example 4, soft sulfide glass is arranged around the Mg-containing particle, and thus it is presumed that the crack of the mixture layer can be inhibited even when the number of charge and discharge cycles is further increased. Also, it is considered that there was a little void in the mixture layer in Example 4, although it was dense. For this reason, it was presumed that the volume change due to intercalation and desorption of Li can also be inhibited.

### REFERENCE SIGNS LIST

1 anode active material layer
2 anode current collector
3 cathode active material layer
4 cathode current collector
5 solid electrolyte layer
6 protective layer
6a mixture layer
6b Mg layer
10 all solid state battery

What is claimed is:

1. An all solid state battery comprising an anode including at least an anode current collector, a cathode, and a solid electrolyte layer arranged between the anode and the cathode; wherein
a protective layer containing Mg is arranged between the anode current collector and the solid electrolyte layer; and
the protective layer includes a mixture layer including a Mg-containing particle containing the Mg, and a solid electrolyte.

2. The all solid state battery according to claim 1,
wherein, in the mixture layer, a proportion of the Mg-containing particle with respect to a total of the Mg-containing particle and the solid electrolyte is 10 weight % or more and 90 weight % or less.

3. The all solid state battery according to claim 1, wherein each of the solid electrolyte included in the solid electrolyte layer and the solid electrolyte included in the mixture layer is a sulfide solid electrolyte.

4. The all solid state battery according to claim 1, wherein the protective layer includes a Mg layer that is a metal thin film containing the Mg, in a position closer to the anode current collector side than the mixture layer.

5. The all solid state battery according to claim 1, wherein the anode includes an anode active material layer containing a deposited Li between the anode current collector and the solid electrolyte layer.

6. The all solid state battery according to claim 1, wherein the anode does not include an anode active material layer containing a deposited Li between the anode current collector and the solid electrolyte layer.

7. The all solid state battery according to claim 1, wherein a filling rate of the mixture layer is 70% or more.

8. A method for producing an all solid state battery including an anode including at least an anode current collector, a cathode, and a solid electrolyte layer arranged between the anode and the cathode; wherein
a protective layer containing Mg is arranged between the anode current collector and the solid electrolyte layer; and
the protective layer includes a mixture layer including a Mg-containing particle containing the Mg, and a sulfide glass;
the method comprising:
a particle layer forming step of forming a particle layer including the Mg-containing particle on the anode current collector;
a precursor layer forming step of forming a precursor layer by impregnating the particle layer with a sulfide glass solution in which the sulfide glass is dissolved in a solvent; and
a mixture layer forming step of obtaining the mixture layer by drying the precursor layer.

9. The method for producing the all solid state battery according to claim 9, wherein the sulfide glass has a composition represented by Li₇₋ₐPS₆₋ₐXₐ, wherein X is at least one kind of Cl, Br, and I, and “a” is a number of 0 or more and 2 or less.

10. The method for producing the all solid state battery according to claim 8, wherein a content of the sulfide glass in the sulfide glass solution is 10 weight % or more and 30 weight % or less.

11. The method for producing the all solid state battery according to claim 8, wherein the drying in the mixture layer forming step is at a temperature of 60° C. or more and 80° C. or less.
